(19) United States
(12) Patent Application Publication
(10) Pub. No.: US 2021/0233170 A1
(43) Pub. Date: Jul. 29, 2021

(54) METHODS AND SYSTEMS FOR PROVIDING A CENTRAL BANK DIGITAL CURRENCY CROSS BORDER PAYMENT SERVICE

(71) Applicant: Carmelle Perpetuelle Maritza Racine Cadet, New York, NY (US)

(72) Inventor: Carmelle Perpetuelle Maritza Racine Cadet, New York, NY (US)

(21) Appl. No.: 17/155,428

(22) Filed: Jan. 22, 2021

Related U.S. Application Data
(60) Provisional application No. 62/964,960, filed on Jan. 23, 2020.

(51) Int. Cl. G06Q 40/04; G06Q 20/38; G06Q 20/22; G06Q 40/02; G06Q 20/06; G06Q 20/02; G06Q 40/00; G06Q 20/24; G06F 9/54

(52) U.S. Cl. CPC G06Q 40/04; G06Q 20/389; G06Q 20/223; G06Q 40/02; G06F 9/547; G06Q 20/02; G06Q 40/12; G06Q 20/24; G06Q 20/0655

(57) ABSTRACT

A method for the modification of a balance associated with a blockchain account on a plurality of cross-border digital currency (CBDC) systems includes establishing, by a CBDC system, via an integrated, Application Programming Interfaced-based, digital currency integrator mechanism, a peer-to-peer bi-lateral payment agreement with a fiat-based account. The method includes assigning, by the CBDC system, to a user application, a token in a blockchain. The method includes receiving, by a messaging layer integrated into the CBDC system, from the user application, an identification of a request for a banking transaction and an identification of the token. The method includes executing, by the CBDC system, in the blockchain, a smart contract transaction associated with the banking transaction. The method includes directing, by the CBDC system, via the integrator mechanism, the fiat-based account to modify an account identified in the request for the banking transaction in accordance with the smart contract transaction.

### CROSS-REFERENCE TO RELATED APPLICATIONS

This application claims priority from U.S. Provisional Patent Application No. 62/964,960, filed on Jan. 23, 2020, entitled “Methods and Systems for Providing a Central Bank Digital Currency Cross Border Payment Service,” which is hereby incorporated by reference.

### BACKGROUND

This disclosure relates to digital currency. More particularly, the methods and systems described herein relate to functionality for providing a central bank digital currency cross border payment service.

Some central banks are issuing digital currency using their own block chain networks (e.g., instead of or in addition to issuing conventional currency, such as dollars or euro). Centralized, traceable digital current provides a controlled and cost-effective way of distributing money. A Central Bank Digital Currency (CBDC) exists when a country's Central Bank or Monetary Authority issues sovereign currency on a blockchain-based network via tokenization capabilities (which may be referred to as the CBDC); when a Central Bank Digital Currency is accepted by the country's regulatory and legal frameworks as a “Legal Tender”; and when the CBDC represents the country's sovereign currency with a 1 to 1 ratio, fully managed by the Central Bank. Conventionally, rather than transacting and settling through a common central bank in which both parties hold reserve accounts, banks route payments through correspondent and other interbank payment networks, entailing extra time, costs, and risk. A CBDC could allow retail users to send payments, including remittances, across borders in a manner that reduces the need for intermediaries.

However, a central bank may need to allow foreign entities to hold the CBDC, which raises complex legal or financial integrity questions. As a result, where cross-border payments involve a foreign-exchange transaction from a domestic CBDC to another country's CBDC, or to other types of currencies such as fiat or crypto currencies, present-day currency conversion frictions remain. The conventional system typically requires either that a foreign-exchange market-making intermediary is willing to assume foreign-exchange risk or that the transacting commercial banks hold accounts in foreign CBDC. Therefore, there is a need for technical solutions for financial institutions that have central banking approval to make cross-border financial transactions to implement secure means for completing such transactions.

### BRIEF DESCRIPTION

In one aspect, a method for the modification of a balance associated with a blockchain account on a plurality of cross-border digital currency (CBDC) systems includes establishing, by a CBDC system, via an integrated, Application Programming Interfaced-based, digital currency integrator mechanism, a peer-to-peer bi-lateral payment agreement with a fiat-based account. The method includes assigning, by the CBDC system, to a user application, a token in a blockchain. The method includes receiving, by a messaging layer integrated into the CBDC system, from the user application, an identification of a request for a banking transaction and an identification of the token. The method includes executing, by the CBDC system, in the blockchain, a smart contract transaction associated with the banking transaction. The method includes directing, by the CBDC system, via the integrator mechanism, the fiat-based account to modify an account identified in the request for the banking transaction in accordance with the smart contract transaction.

In another aspect, a method for the modification of a balance associated with a blockchain account on a plurality of cross-border digital currency (CBDC) systems includes establishing, by a CBDC system, via an integrated, Application Programming Interfaced-based, digital currency integrator mechanism, a peer-to-peer bi-lateral payment agreement with a representative money account. The method includes assigning, by the CBDC system, to a user application, a token in a blockchain. The method includes receiving, by a messaging layer integrated into the CBDC system, from the user application, an identification of a request for a banking transaction and an identification of the token. The method includes executing, by the CBDC system, in the blockchain, a smart contract transaction associated with the banking transaction. The method includes directing, by the CBDC system, the representative money account to modify an account identified in the request for the banking transaction in accordance with the smart contract transaction.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is a block diagram depicting an embodiment of a system for providing a central bank digital currency cross border payment service;

FIG. 2A is a flow diagram depicting an embodiment of a method for modification of a balance associated with a blockchain account on a plurality of cross-border digital currency (CBDC) systems;

FIG. 2B is a flow diagram depicting an embodiment of a method for modification of a balance associated with a blockchain account on a plurality of cross-border digital currency (CBDC) systems; and

FIGS. 3A-3C are block diagrams depicting embodiments of computers useful in connection with the methods and systems described herein.

### DETAILED DESCRIPTION

The methods and systems described herein may provide functionality for providing a central bank digital currency cross border payment service. In one aspect, the methods and systems described herein provide functionality that facilitates and consolidates ingoing and outgoing payment messages for a transaction between two parties (Party A and Party B) in at least 2 different jurisdictions (Country A and Country B), where the message specifies the amount of a payment that either:
originates from a CBDC Account A—Settles/Distributes in a CBDC Account B;
originates from a CBDC Account A—Settles/Distributes in a Fiat Account B;
originates from a CBDC Account A—Settles/Distributes in a Fiat Account B;
originates from a Fiat Account A—Settles/Distributes in a CBDC Account B;
originates from a Fiat Account A—Settles in CBDC A or B or Z—and Distributes in a Fiat Account B; or
originates from a CBDC Account A—Settles in an alternative crypto currency—and Distributes in a Fiat Account B.

In some embodiments, the method allows for the customization of a wallet (e.g., blockchain account) on both Party A's CBDC System and Party B's CBDC System. The method may allow for the hybrid integration allowing a Non-Blockchain Banking System to access both fiat-based accounts and a CBDC System or to access both representative money accounts and the CBDC system. The method may leverage smart contract services (including those provided by using a blockchain) to establish and maintain Peer to Peer Bilateral Agreements that ensure various compliance models. The method may provide peer to peer Cross Border Payment Service for Financial Institution, Non-Banks, Central Banks and Consumers Platforms for CBDC-based payments. The method may leverage artificial intelligence to predict multi-currency risk management, liquidity risk management and predictive analysis for end-to-end CBDC and Fiat payments management.

Cross-border payments may be performed via regulated financial services providers with their end users engaging via a software application or an online portal or with branch visits. Cross-border payments may be managed via multi-account recording and an optional netting mechanism.

In one embodiment, the methods and systems described herein provide an application for cross-border payment that the bank can use to conduct these transactions. For example, the application may include a mechanism that combines a messaging layer integrated into a central bank's digital currency (e.g., for indicating that there is a transaction to be made), using blockchain with tokens to provide accountability and scale. As another example, the application may include a contracting mechanism for entering bilateral agreements (e.g., the smart contract functionality indicated above). As a further example, the application may include a dashboard providing an integrated view of contracts and transactions. Such a dashboard may provide a unified view of the contracting mechanism and the messaging layer.

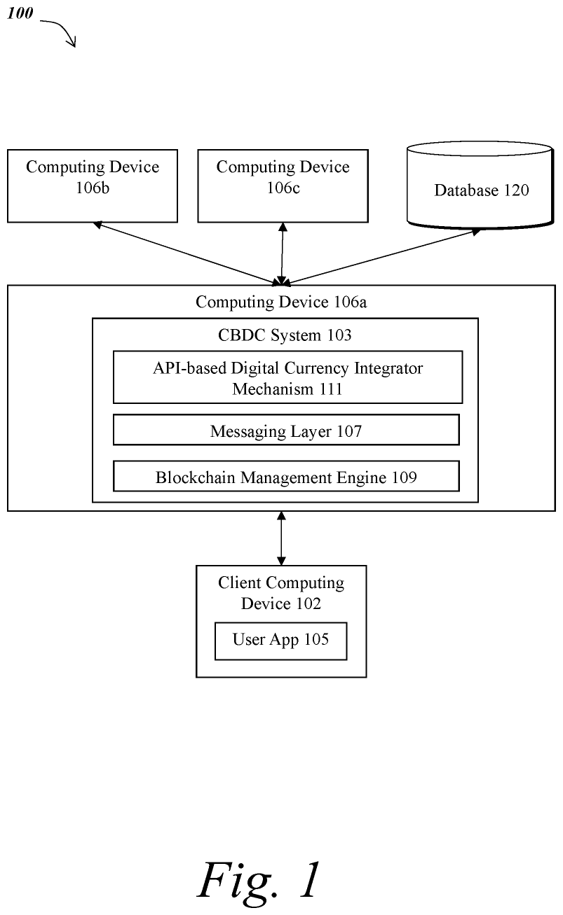

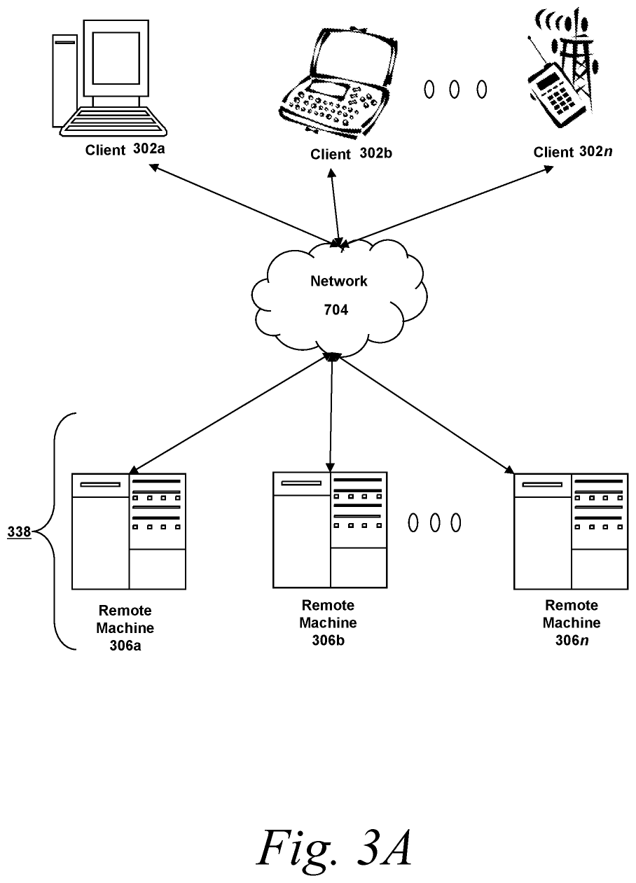

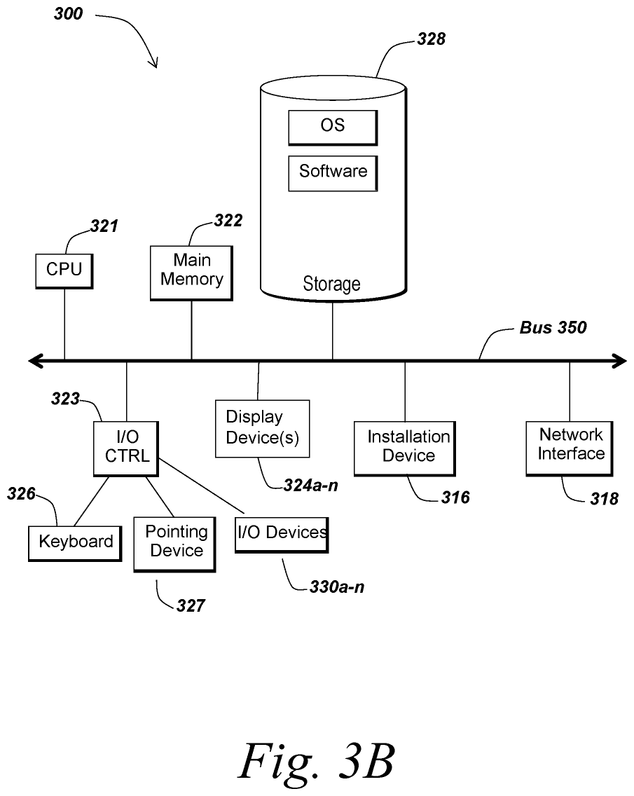

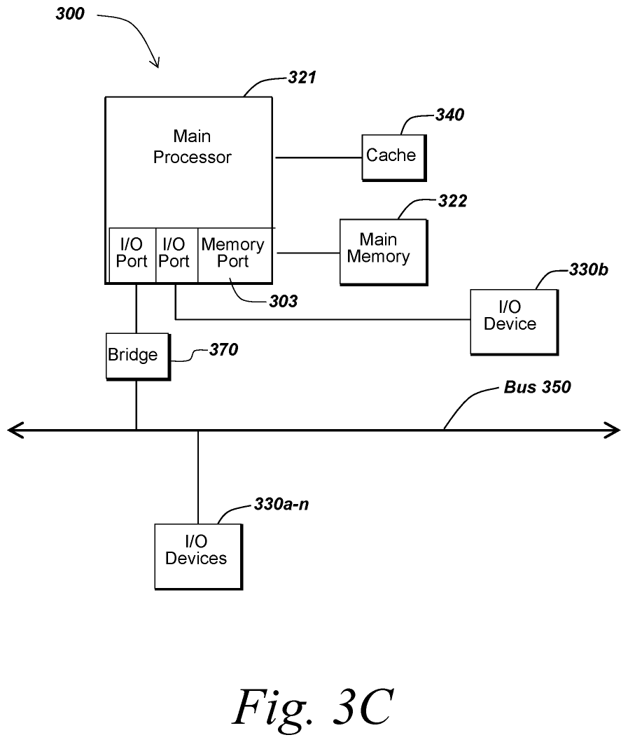

Referring now to FIG. 1, and in brief overview, a system 100 includes a computing device 106a, a computing device 106b, a client computing device 102, a CBDC system 103, a user app 105, a messaging layer 107, a blockchain management engine 109, an Application Programming Interfaced-based digital currency integrator mechanism, and a database 120. The computing devices 106a, 106b, and 102 may be a modified type or form of computing device (as described in greater detail below in connection with FIGS. 3A-C) that have been modified to execute instructions for providing the functionality described herein; these modifications result in a new type of computing device that provides a technical solution to problems rooted in computer technology.

Referring now to FIG. 1 in greater detail, the CBDC system 103 may be provided as a software component. The CBDC system 103 may be provided as a hardware component. The computing device 106a may execute the CBDC system 103. The CBDC system 103 may be in communication with one or more computing devices 106c associated with one or more banking systems. The CBDC system 103 may be in communication with one or more nodes 106b in a blockchain network.

The messaging layer 107 may be provided as a software component. The messaging layer 107 may be provided as a hardware component. The computing device 106a may execute the messaging layer 107.

The CBDC system 103 may include or be in communication with the database 120. The database 120 may be an ODBC-compliant database. For example, the database 120 may be provided as an ORACLE database, manufactured by Oracle Corporation of Redwood Shores, Calif. In other embodiments, the database 120 can be a Microsoft ACCESS database or a Microsoft SQL server database, manufactured by Microsoft Corporation of Redmond, Wash. In other embodiments, the database 120 can be a SQLite database distributed by Hwaci of Charlotte, N.C., or a PostgreSQL database distributed by The PostgreSQL Global Development Group. In still other embodiments, the database 120 may be a custom-designed database based on an open source database, such as the MYSQL family of freely available database products distributed by Oracle Corporation of Redwood City, Calif. In other embodiments, examples of databases include, without limitation, structured storage (e.g., NoSQL-type databases and BigTable databases), HBase databases distributed by The Apache Software Foundation of Forest Hill, Md., MongoDB databases distributed by 10Gen, Inc., of New York, N.Y., an AWS DynamoDB distributed by Amazon Web Services and Cassandra databases distributed by The Apache Software Foundation of Forest Hill, Md. In further embodiments, the database 120 may be any form or type of database.

The user application 105 may be provided as a software component. The user application 105 may be provided as a hardware component. The computing device 102 may execute the user application 105.

The Application Programming Interfaced-based digital currency integrator mechanism 111 may be provided as a software component. The API-based digital currency integrator mechanism 111 may be provided as a hardware component. The computing device 102 may execute the API-based digital currency integrator mechanism 111.

Although, for ease of discussion, the CBDC system 103, the user app 105, the messaging layer 107, the blockchain management engine 109, the API-based digital currency integrator mechanism 111, and the database 120 are described in FIG. 1 as separate modules, it should be understood that this does not restrict the architecture to a particular implementation. For instance, these components may be encompassed by a single circuit or software function or, alternatively, distributed across a plurality of computing devices.

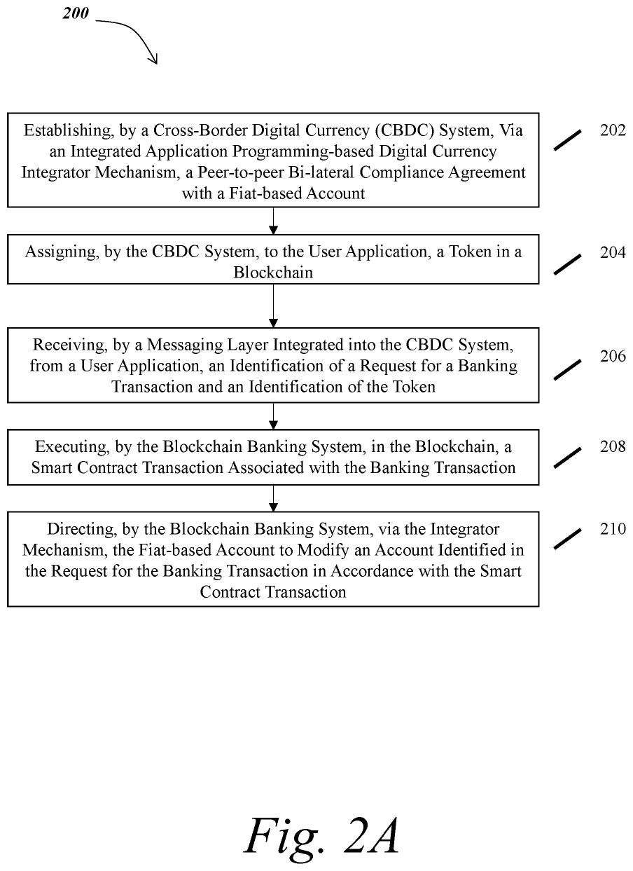

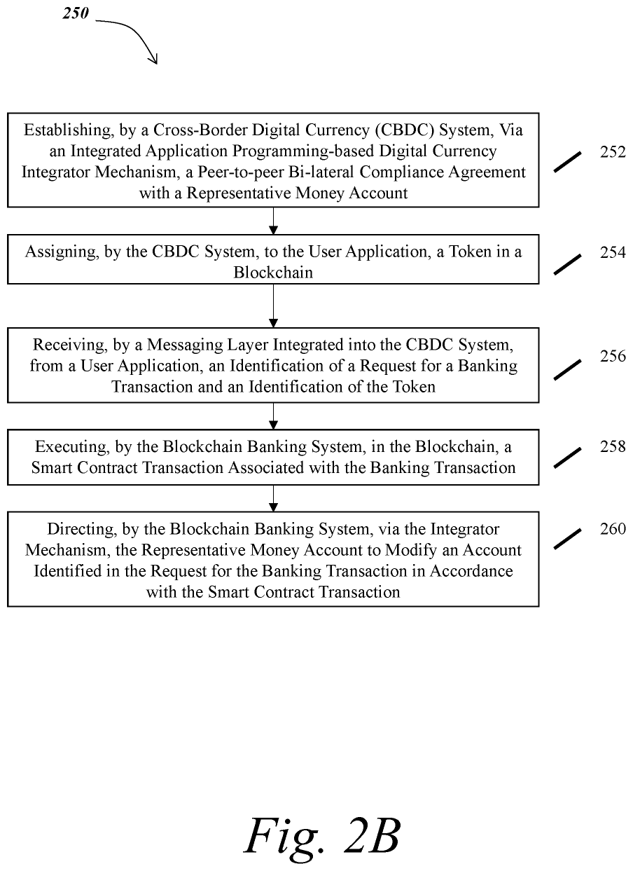

Referring now to FIG. 2A, in brief overview, a flow diagram depicts one embodiment of a method 200 for the modification of a balance associated with a blockchain account on a plurality of cross-border digital currency (CBDC) systems. The method 200 includes establishing, by a CBDC system, via an integrated, Application Programming Interfaced-based, digital currency integrator mechanism, a peer-to-peer bi-lateral payment agreement with a fiat-based account (202). The method 200 includes assigning, by the CBDC system, to a user application, a token in a blockchain (204). The method 200 includes receiving, by a messaging layer integrated into the CBDC system, from the user application, an identification of a request for a banking transaction and an identification of the token (206). The method 200 includes executing, by the CBDC system, in the blockchain, a smart contract transaction associated with the banking transaction (208). The method 200 includes directing, by the CBDC system, via the integrator mechanism, the fiat-based account to modify an account identified in the request for the banking transaction in accordance with the smart contract transaction (210).

Referring now to FIG. 2A, in greater detail and in connection with FIG. 1, the method 200 includes establishing, by a CBDC system, via an integrated, Application Programming Interfaced-based, digital currency integrator mechanism, a peer-to-peer bi-lateral payment agreement with a fiat-based account (202). In one embodiment, a bank maintains the CBDC system 103. In another embodiment, the CBDC system 103 is maintained by an entity that provides a bank with access to the CBDC system 103.

The method 200 includes assigning, by the CBDC system, to a user application, a token in a blockchain (204). In one embodiment, a bank maintains the blockchain. In another embodiment, a bank maintains a computing device 106a in a plurality of computing devices that maintain the blockchain, the plurality of computing devices including the computing device 106b. In still another embodiment, the CBDC system 103 executes a blockchain management engine 109 that manages blockchain-related transactions on behalf of users (including users such as banks).

The token associates the user application with a blockchain-based account, which may be referred to herein as a digital wallet.

The method 200 includes receiving, by a messaging layer integrated into the CBDC system, from the user application, an identification of a request for a banking transaction and an identification of the token (206). In one embodiment, a user of the user application inputs into the user application (e.g., via a user interface) an instruction to use the issued blockchain token to transfer funds from the blockchain account to the fiat-based account, or vice versa; the transaction may require a cross-border transfer of funds. The request may include an identification of a request for a multi-currency transaction. The user application may transmit the identification of the token and the identification of a request for a banking transaction to the CBDC system 103.

The method 200 includes executing, by the CBDC system, in the blockchain, a smart contract transaction associated with the banking transaction (208). The system 100 may use a smart contracts protocol managed by a blockchain (private or public) to create an immutable record of requested and executed transactions. The smart contracts protocol may define a set of functions that allow for the creation, individual ownership, and transfer of funds represented in the user blockchain account (which the user may refer to as a “wallet” or a “digital wallet).

As will be understood by those of skill in the art, a smart contract is a software component that is deployed to and stored on a blockchain. A smart contract includes a state and a set of instructions (e.g., functions) for mutating the state. To store data in a smart contract on the blockchain is to update its state using one or more instructions in the set of instructions. The system 100 may include a public blockchain. The system 100 may include a private blockchain. The system 100 may include functionality for storing data (e.g., making changes to the state of the smart contract) by sending data to a node within a blockchain network that is kept in sync with other nodes in the blockchain network. The computing device 106a (e.g., via the blockchain management engine 109) may send data to one or more other nodes within the blockchain network, which then propagates the changed data to other nodes in the blockchain network.

The method 200 includes directing, by the CBDC system, via the integrator mechanism, the fiat-based account to modify an account identified in the request for the banking transaction in accordance with the smart contract transaction (210).

The method 200 may include generating, by the CBDC system, a report of transactions including an identification of the requested banking transaction. The method 200 may include generating, by the CBDC system, an audit of transactions including an identification of the requested banking transaction. The method 200 may include generating, by the CBDC system, a treasury management report including an identification of the requested banking transaction. The method 200 may include generating, by the CBDC system, a regulatory report including an identification of the requested banking transaction.

Referring now to FIG. 2B, and in connection with FIG. 2A, a flow diagram depicts one embodiment of a method 200 for the modification of a balance associated with a blockchain account on a plurality of cross-border digital currency (CBDC) systems. The method 250 includes establishing, by a CBDC system, via an integrated, Application Programming Interfaced-based, digital currency integrator mechanism, a peer-to-peer bi-lateral payment agreement with a representative money account (e.g., credit cards, checks, or other such instruments) (252). The method 250 includes assigning, by the CBDC system, to a user application, a token in a blockchain (254). The method 250 includes receiving, by a messaging layer integrated into the CBDC system, from the user application, an identification of a request for a banking transaction and an identification of the token (256). The request may include an identification of a request for a credit card transaction. The request may include an identification of a request for a multi-currency transaction. The method 250 includes executing, by the CBDC system, in the blockchain, a smart contract transaction associated with the banking transaction (258). The method 250 includes directing, by the CBDC system, via the integrator mechanism, the representative money account to modify an account identified in the request for the banking transaction in accordance with the smart contract transaction (260). The steps (252) through (260) may be executed as described above in connection with FIG. 2A, although the account is not a fiat-based account but a representative money account.

In some embodiments, the system 100 includes non-transitory, computer-readable medium comprising computer program instructions tangibly stored on the non-transitory computer-readable medium, wherein the instructions are executable by at least one processor to perform each of the steps described above in connection with FIG. 2.

It should be understood that the systems described above may provide multiple ones of any or each of those components and these components may be provided on either a standalone machine or, in some embodiments, on multiple machines in a distributed system. The phrases ‘in one embodiment,’ ‘in another embodiment,’ and the like, generally mean that the particular feature, structure, step, or characteristic following the phrase is included in at least one embodiment of the present disclosure and may be included in more than one embodiment of the present disclosure. Such phrases may, but do not necessarily, refer to the same embodiment. However, the scope of protection is defined by the appended claims; the embodiments mentioned herein provide examples.

The systems and methods described above may be implemented as a method, apparatus, or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be LISP, PROLOG, PERL, C, C++, C#, JAVA, or any compiled or interpreted programming language.

Each such computer program may be implemented in a computer program product tangibly embodied in a machine-readable storage device for execution by a computer processor. Method steps may be performed by a computer processor executing a program tangibly embodied on a computer-readable medium to perform functions of the methods and systems described herein by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip; electronic devices; a computer-readable non-volatile storage unit; non-volatile memory, such as semiconductor memory devices, including EPROM, EEPROM, and flash memory devices; magnetic disks such as internal hard disks and removable disks; magneto-optical disks; and CD-ROMs). Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data (including, for example, instructions for storage on non-transitory computer-readable media) from a second computer providing access to the programs via a network transmission line, wireless transmission media, signals propagating through space, radio waves, infrared signals, etc.

Referring now to FIGS. 3A, 3B, and 3C, block diagrams depict additional detail regarding computing devices that may be modified to execute novel, non-obvious functionality for implementing the methods and systems described above.

Referring now to FIG. 3A, an embodiment of a network environment is depicted. In brief overview, the network environment comprises one or more clients 302a-302n (also generally referred to as local machine(s) 302, client(s) 302, client node(s) 302, client machine(s) 302, client computer(s) 302, client device(s) 302, computing device(s) 302, endpoint(s) 302, or endpoint node(s) 302) in communication with one or more remote machines 306a-306n (also generally referred to as server(s) 306 or computing device(s) 306) via one or more networks 304.

Although FIG. 3A shows a network 304 between the clients 302 and the remote machines 306, the clients 302 and the remote machines 306 may be on the same network 304. The network 304 can be a local area network (LAN), such as a company Intranet, a metropolitan area network (MAN), or a wide area network (WAN), such as the Internet or the World Wide Web. In some embodiments, there are multiple networks 304 between the clients 302 and the remote machines 306. In one of these embodiments, a network 304′ (not shown) may be a private network and a network 304 may be a public network. In another of these embodiments, a network 304 may be a private network and a network 304′ a public network. In still another embodiment, networks 304 and 304′ may both be private networks. In yet another embodiment, networks 304 and 304′ may both be public networks.

The network 304 may be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, an SDH (Synchronous Digital Hierarchy) network, a wireless network, and a wireline network. In some embodiments, the network 304 may comprise a wireless link, such as an infrared channel or satellite band. The topology of the network 304 may be a bus, star, or ring network topology. The network 304 may be of any such network topology as known to those ordinarily skilled in the art capable of supporting the operations described herein. The network may comprise mobile telephone networks utilizing any protocol or protocols used to communicate among mobile devices (including tables and handheld devices generally), including AMPS, TDMA, CDMA, GSM, GPRS, UMTS, or LTE. In some embodiments, different types of data may be transmitted via different protocols. In other embodiments, the same types of data may be transmitted via different protocols.

A client 302 and a remote machine 306 (referred to generally as computing devices 300) can be any workstation, desktop computer, laptop or notebook computer, server, portable computer, mobile telephone, mobile smartphone, or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A client 302 may execute, operate or otherwise provide an application, which can be any type and/or form of software, program, or executable instructions, including, without limitation, any type and/or form of web browser, web-based client, client-server application, an ActiveX control, or a JAVA applet, or any other type and/or form of executable instructions capable of executing on client 302.

In one embodiment, a computing device 306 provides functionality of a web server. In some embodiments, a web server 306 comprises an open-source web server, such as the APACHE servers maintained by the Apache Software Foundation of Delaware. In other embodiments, the web server executes proprietary software, such as the INTERNET INFORMATION SERVICES products provided by Microsoft Corporation of Redmond, Wash., the ORACLE IPLANET web server products provided by Oracle Corporation of Redwood Shores, Calif., or the ORACLE WEBLOGIC products provided by Oracle Corporation of Redwood Shores, Calif.

In some embodiments, the system may include multiple, logically-grouped remote machines 306. In one of these embodiments, the logical group of remote machines may be referred to as a server farm 338. In another of these embodiments, the server farm 338 may be administered as a single entity.

FIGS. 3B and 3C depict block diagrams of a computing device 300 useful for practicing an embodiment of the client 302 or a remote machine 306. As shown in FIGS. 3B and 3C, each computing device 300 includes a central processing unit 321, and a main memory unit 322. As shown in FIG. 3B, a computing device 300 may include a storage device 328, an installation device 316, a network interface 318, an I/O controller 323, display devices 324a-n, a keyboard 326, a pointing device 327, such as a mouse, and one or more other I/O devices 330a-n. The storage device 328 may include, without limitation, an operating system and software. As shown in FIG. 3C, each computing device 300 may also include additional optional elements, such as a memory port 303, a bridge 370, one or more input/output devices 330a-n (generally referred to using reference numeral 330), and a cache memory 340 in communication with the central processing unit 321.

The central processing unit 321 is any logic circuitry that responds to and processes instructions fetched from the main memory unit 322. In many embodiments, the central processing unit 321 is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; those manufactured by International Business Machines of White Plains, N.Y.; or those manufactured by Advanced Micro Devices of Sunnyvale, Calif. Other examples include SPARC processors, ARM processors, processors used to build UNIX/LINUX “white” boxes, and processors for mobile devices. The computing device 300 may be based on any of these processors, or any other processor capable of operating as described herein.

Main memory unit 322 may be one or more memory chips capable of storing data and allowing any storage location to be directly accessed by the main processor 321. The main memory 322 may be based on any available memory chips capable of operating as described herein. In the embodiment shown in FIG. 3B, the processor 321 communicates with main memory 322 via a system bus 350. FIG. 3C depicts an embodiment of a computing device 300 in which the processor communicates directly with main memory 322 via a memory port 303. FIG. 3C also depicts an embodiment in which the main processor 321 communicates directly with cache memory 340 via a secondary bus, sometimes referred to as a backside bus. In other embodiments, the main processor 321 communicates with cache memory 340 using the system bus 350.

In the embodiment shown in FIG. 3B, the processor 321 communicates with various I/O devices 330 via a local system bus 350. Various buses may be used to connect the central processing unit 321 to any of the I/O devices 330, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 324, the processor 321 may use an Advanced Graphics Port (AGP) to communicate with the display 324. FIG. 3C depicts an embodiment of a computing device 300 in which the main processor 321 also communicates directly with an I/O device 330b via, for example, HYPERTRANSPORT, RAPIDIO, or INFINIBAND communications technology.

One or more of a wide variety of I/O devices 330a-n may be present in or connected to the computing device 300, each of which may be of the same or different type and/or form. Input devices include keyboards, mice, trackpads, trackballs, microphones, scanners, cameras, and drawing tablets. Output devices include video displays, speakers, inkjet printers, laser printers, 3D printers, and dye-sublimation printers. The I/O devices may be controlled by an I/O controller 323 as shown in FIG. 3B. Furthermore, an I/O device may also provide storage and/or an installation device 316 for the computing device 300. In some embodiments, the computing device 300 may provide USB connections (not shown) to receive handheld USB storage devices such as the USB Flash Drive line of devices manufactured by Twintech Industry, Inc. of Los Alamitos, Calif.

Referring still to FIG. 3B, the computing device 300 may support any suitable installation device 316, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive or any other device suitable for installing software and programs. In some embodiments, the computing device 300 may provide functionality for installing software over a network 304. The computing device 300 may further comprise a storage device, such as one or more hard disk drives or redundant arrays of independent disks, for storing an operating system and other software. Alternatively, the computing device 300 may rely on memory chips for storage instead of hard disks.

Furthermore, the computing device 300 may include a network interface 318 to interface to the network 304 through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, 802.15.4, Bluetooth, ZIGBEE, CDMA, GSM, WiMax, and direct asynchronous connections). In one embodiment, the computing device 300 communicates with other computing devices 300′ via any type and/or form of gateway or tunneling protocol such as Secure Socket Layer (SSL) or Transport Layer Security (TLS). The network interface 318 may comprise a built-in network adapter, network interface card, PCMCIA network card, card bus network adapter, wireless network adapter, USB network adapter, modem, or any other device suitable for interfacing the computing device 300 to any type of network capable of communication and performing the operations described herein.

In further embodiments, an I/O device 330 maybe a bridge between the system bus 350 and an external communication bus, such as a USB bus, an Apple Desktop Bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

A computing device 300 of the sort depicted in FIGS. 3B and 3C typically operates under the control of operating systems, which control scheduling of tasks and access to system resources. The computing device 300 can be running any operating system such as any of the versions of the MICROSOFT WINDOWS operating systems, the different releases of the UNIX and LINUX operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS 7, WINDOWS 8, and WINDOWS VISTA, WINDOWS 10 all of which are manufactured by Microsoft Corporation of Redmond, Wash.; MAC OS manufactured by Apple Inc. of Cupertino, Calif.; OS/2 manufactured by International Business Machines of Armonk, N.Y.; Red Hat Enterprise Linux, a Linus-variant operating system distributed by Red Hat, Inc., of Raleigh, N.C.; Ubuntu, a freely-available operating system distributed by Canonical Ltd. of London, England; or any type and/or form of a Unix operating system, among others.

Having described certain embodiments of methods and systems for providing a central bank digital currency cross border payment service, it will be apparent to one of skill in the art that other embodiments incorporating the concepts of the disclosure may be used. Therefore, the disclosure should not be limited to certain embodiments, but rather should be limited only by the spirit and scope of the following claims.

What is claimed is:

1. A method for the modification of a balance associated with a blockchain account on a plurality of cross-border digital currency (CBDC) systems, the method comprising:
establishing, by a CBDC system, via an integrated Application Programming Interfaced-based digital currency integrator mechanism, a peer-to-peer bi-lateral payment agreement with a fiat-based account;
assigning, by the CBDC system, to a user application, a token in a blockchain;
receiving, by a messaging layer integrated into the CBDC system, from the user application, an identification of a request for a banking transaction and an identification of the token;
executing, by the CBDC system, in the blockchain, a smart contract transaction associated with the banking transaction; and
directing, by the CBDC system, via the integrator mechanism, the fiat-based account to modify an account identified in the request for the banking transaction in accordance with the smart contract transaction.

2. The method of claim 1, wherein receiving, further comprises receiving, by the messaging layer, from the user application, an identification of a request for a multi-currency transaction.

3. The method of claim 1 further comprising generating, by the CBDC system, a report of transactions including an identification of the requested banking transaction.

4. The method of claim 1 further comprising generating, by the CBDC system, an audit of transactions including an identification of the requested banking transaction.

5. The method of claim 1 further comprising generating, by the CBDC system, a treasury management report including an identification of the requested banking transaction.

6. The method of claim 1 further comprising generating, by the CBDC system, a regulatory report including an identification of the requested banking transaction.

7. A method for the modification of a balance associated with a blockchain account on a plurality of cross-border digital currency (CBDC) systems, the method comprising:
establishing, by a CBDC system, via an integrated Application Programming Interfaced-based digital currency integrator mechanism, a peer-to-peer bi-lateral payment agreement with a representative money account;
assigning, by the CBDC system, to a user application, a token in a blockchain;
receiving, by a messaging layer integrated into the CBDC system, from the user application, an identification of a request for a banking transaction and an identification of the token;
executing, by the CBDC system, in the blockchain, a smart contract transaction associated with the banking transaction; and
directing, by the CBDC system, via the integrator mechanism, the representative money account to modify an account identified in the request for the banking transaction in accordance with the smart contract transaction.

8. The method of claim 1, wherein receiving, further comprises receiving, by the messaging layer, from the user application, an identification of a request for a credit card transaction.

9. The method of claim 1, wherein receiving, further comprises receiving, by the messaging layer, from the user application, an identification of a request for a multi-currency transaction.

10. The method of claim 1 further comprising generating, by the CBDC system, a report of transactions including an identification of the requested banking transaction.

11. The method of claim 1 further comprising generating, by the CBDC system, an audit of transactions including an identification of the requested banking transaction.

12. The method of claim 1 further comprising generating, by the CBDC system, a treasury management report including an identification of the requested banking transaction.

13. The method of claim 1 further comprising generating, by the CBDC system, a regulatory report including an identification of the requested banking transaction.
